(19) United States
(12) Patent Application Publication
(10) Pub. No.: US 2005/0105730 A1
(43) Pub. Date: May 19, 2005

(54) Descrambler for descrambling scrambled data

(75) Inventor: Kenji Kasamura, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 10/986,306

(22) Filed: Nov. 12, 2004

(30) Foreign Application Priority Data
Nov. 13, 2003 (JP) 2003-384203

(51) Int. Cl. H04N 7/167; H04L 9/00

(52) U.S. Cl. 380/210

(57) ABSTRACT

A descrambler can speed up descrambling and prevent an increase in circuit scale. Received data is descrambled by an EXOR gate that receives a PN pattern signal output from a scramble pattern generator. The data is then converted to parallel data, and the CRC error correction is performed on the parallel data by a 1-bit error corrector. The 160-bit data, on which scrambling is performed is supplied to a parallel EXOR gate. When a PN pattern for descrambling scrambled data is generated by a user scramble pattern generator, the PN pattern output is converted to 160-bit parallel data, and is supplied to the parallel EXOR gate. The 160 EXOR gates descramble the input data bit by bit in parallel.

### BACKGROUND OF THE INVENTION

1. Field of the Invention

The present invention relates to a descrambler for descrambling scrambled data.

2. Description of the Background Art

Recently, widely used are mobile wireless communication devices such as cellular phone terminals and PHS (Personal Handy Phone System) terminals. The user scrambling during transmission is regulated by RCR STD-28 (Second Generation Cordless Telephone System or Personal Handy Phone System Standard). A PHS terminal has the user scrambling function. To perform this user scrambling, the initial value of the shift register for scrambling is generated from a encryption key code generated for each call and, based on the generated initial value, a PN (Pseudo Noise) pattern is generated. The user scrambling processing is performed by operating exclusive OR on this PN pattern and TCH data, 160 bits) to generate data, DATASEC. To this data, DATASEC, the CI bits (4 bits) and the SA bits (16 bits) are added, and the CRC operation is performed on the data comprised of a total of 180 bits, the CRC bits being added to the end of the 180-bit data to generate 196-bit data. Next, the scrambling is performed on the parts corresponding to the data, DATASEC, and the CRC bits, which are parts of the 196-bit data, to generate the data, DATASCR, and the PR bits (8 bits) and the UW bits are added to the generated data to create data composed of a total of 220 bits. The data created in this way will be transmitted.

During reception, the descrambling is performed on the bits corresponding to the received data, DATASCR. Next, the CRC check and the error correction are performed on the descrambled data and, finally, the user descrambling is performed on the bits corresponding to the data, DATASEC, to generate the original TCH data. More specifically, the descrambling is performed by exclusively ORing the received data with the PN pattern, the processed data is converted to parallel data by the serial-to-parallel conversion circuit, and the error correction is performed by the 1-bit error correction circuit. The error-corrected data output from the 1-bit error correction circuit is divided into two parts, that is, 44-bit data, P_PR2SA, from the PR bits to the SA bits and 160-bit data, P_DATASEC, for which the user scrambling was performed. These two parts are output.

The data, P_DATASEC, is further converted to serial data by the parallel-to-serial conversion circuit and connected to one of the inputs of the exclusive OR gate. The user scramble and descrambling PN pattern data, PNSEC, which is output from the user scramble pattern generation circuit, is input to the other input of the exclusive OR gate. As a result of this operation on this data, the data, TCH, for which user descrambling is performed is supplied from the exclusive OR gate to the serial-to-parallel conversion circuit. The data, P_TCH, converted to parallel form by the serial-to-parallel conversion circuit and the 44-bit data, P_PR2SA, output from the error correction circuit are input to and stored in the reception data storage register.

A user scrambling device for use in a communications system, where a speech is transmitted alternately between calling and called parties, is disclosed, for example, in Japanese Patent Laid-Open Publication No. 30102/1993. RCR STD-28 described above was drafted by ARIB (Association of Radio Industries and Businesses) as the standard “Personal Handy Phone System Standard” (Standard RCR STD-28, Revision 3.3 Mar. 3, 2000).

Conventionally, however, received and descrambled data, DESCR_RXD, must be once converted from serial to parallel data, on which the CRC error correction is performed. Therefore, the user descrambling is performed on the error-corrected parallel data, P_DATASEC, that is output after error-corrected. Because data is processed serially in the user descrambling that is performed next, the problem here is that the parallel data, P_DATASEC, must be once converted to serial data, DATASEC, before the user descrambling is performed bit-by-bit on the data.

This means that the user descrambling for 160 bits requires a time period equivalent to at least 160 clocks. Until the situation is settled where the data is established and the received data can be stored in the register, it takes a long period of time, depending upon the internal operational clock frequency. This processing also requires the parallel-to-serial conversion circuit, the serial-to-parallel conversion circuit, and the control circuit for the processing described above. In addition, this configuration complicates the control circuit, which adjusts the output time of the PN pattern, PNSEC, for descrambling the user scrambled data and the output time of the data, DATASEC, and increases the size of the circuit.

### SUMMARY OF THE INVENTION

It is an object of the present invention to provide a descrambler that solves the drawback of the prior art, increases the speed of the descrambling, and prevents an increase in circuit scale.

To solve the above-stated problems, the present invention provides a descrambler for descrambling scrambled parallel data, which comprises a pattern generator for generating a descramble pattern for descrambling the parallel data; a converter for converting the descramble pattern to a parallel form; and an operation circuit connected to the converter for receiving the descramble pattern, which is converted to a parallel form, and the parallel data for performing a bit-by-bit exclusive OR operation. In this case, it is also possible that the descrambler further comprises a corrector for performing error correction on a received signal in a parallel form and outputting the error-corrected signal as parallel data. The operation circuit is connected to an output of the corrector for receiving the parallel data from the corrector.

To solve the above problems, the present invention also provides a descrambler for descrambling scrambled parallel data, which comprises a pattern generator for holding a descramble pattern for descrambling the parallel data, receiving initial value data for descrambling as address data, and outputting descramble pattern data according to the initial value data in a parallel form; and an operation circuit connected to the pattern generator for receiving the descramble pattern data and the parallel data for performing a bit-by-bit exclusive OR operation. In this case, it is also possible that the descrambler further comprises a corrector for performing error correction on a received signal in a parallel form and outputting the error-corrected signal as parallel data. The operation circuit is connected to an output of the corrector for receiving the parallel data from the corrector.

In accordance with the present invention, because the descrambling can be performed on parallel data, the period of time required for outputting descrambled and received data can be reduced. In addition, the descrambler in accordance with the present invention eliminates the need for the parallel-to-serial converter and the complicated control circuit, which were required in the prior art, thus reducing the scale of the circuitry.

In addition, in the configuration where a memory is provided for storing descramble pattern data as the pattern generator, a parallel PN pattern is obtained by supplying initial value data to the address terminal of the memory. This configuration eliminates the need for the scramble pattern generator and the serial-to-parallel converter, and therefore makes the control simpler. When the generation polynomial for the PN pattern is changed, it is only required to rewrite the data stored in the memory.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of a descrambler in according with the present invention;

FIG. 2 is a functional block diagram showing circuitry for user scrambling;

FIG. 3 is a timing chart useful for understanding the operation of the descrambler in the embodiment shown in FIG. 1;

FIG. 4 is a schematic block diagram showing an alternative embodiment of a descrambler; and

FIG. 5 is a timing chart showing an example of the operation of the descrambler shown in FIG. 4.

### DESCRIPTION OF THE PREFERRED EMBODIMENTS

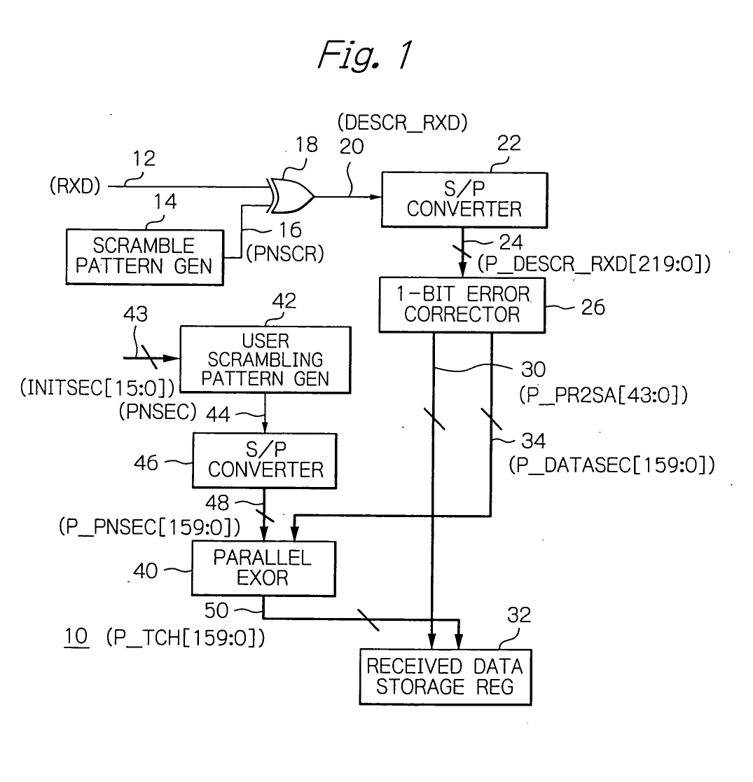

With reference to the accompanying drawings, preferred embodiments of a descrambler according to the present invention will be described in detail. In the description below, portions not directly relevant to understanding the present invention will neither be described nor shown. Referring to FIG. 1, an embodiment 10 of the descrambler according to the present invention comprises an exclusive OR gate 18 connected to an input 12 that receives received data, RXD, and an output 16 of a scramble pattern generation circuit 14. In the description, a signal is designated with the reference numeral of a line over which the signal is transferred.

The scramble pattern generation circuit 14 generates a PN pattern signal, PNSCR, for descrambling scrambled and received data and outputs the generated signal on its output 16. The exclusive OR gate 18 is adapted to carry out the exclusive OR on the received data, RXD, 12 and the PN pattern signal, PNSCR, and outputs the resultant signal, DESCR_RXD, to its output 20.

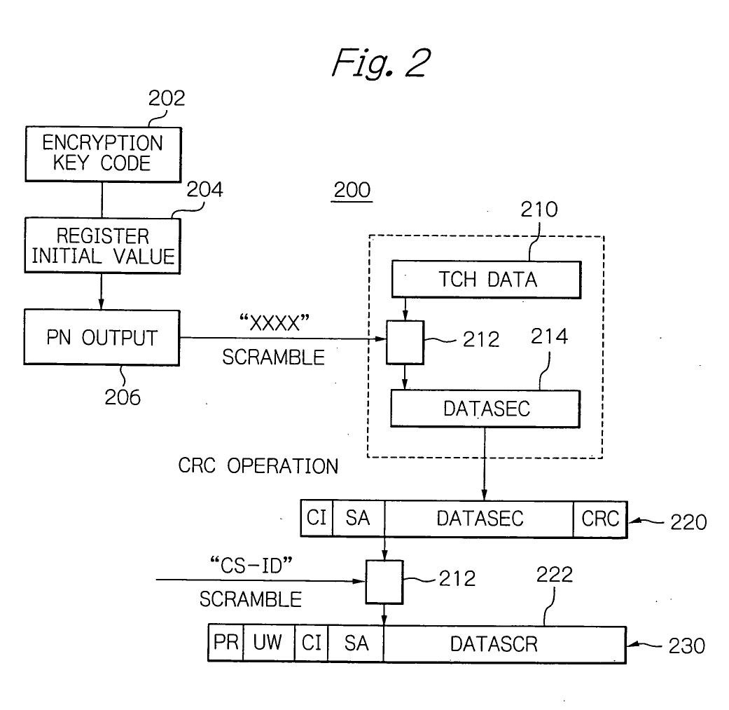

FIG. 2 is the functional block diagram of the user scrambling circuitry provided on a sending side that performs the user scrambling. In a sending processing block 200, a shift register initial value 204 for scrambling is generated first from a encryption key code 202 and, based on the initial value, a PN pattern 206 is generated. Next, an operation circuit 212 performs the exclusive OR on the PN pattern 206 and 160-bit TCH data 210 to perform user scrambling and generates data, DATASEC, 214. Next, the CI bits (4 bits) and the SA bits (16 bits) are added to the data, DATASEC, 214 to create 180-bit data, the CRC operation is performed on the created 180-bit data, and the 16-bit CRC bits are added to the end of the 180-bit data to generate data 220 composed of a total of 196 bits. Next, the operation circuit 212 performs user scrambling, during which the exclusive OR is operated, on the part corresponding to the data, DATASEC, 214 and the CRC operation on the data 220 to generate data, DATASCR, 222. In addition, the PR bits (8 bits) and the UW bits are added to the generated data to create sending data 230 comprised of a total of 220 bits and the created sending data will be sent out.

Returning again to FIG. 1, the sending data 230, on which the user scrambling was performed as described above, is received and demodulated by the receiving device for use in baseband processing. At the receiving device, the data processed as described above is input to the descrambler 10 as the received data, RXD, 12.

A serial output, DESCR_RXD, 20 from the exclusive OR gate 18 is connected to a serial-to-parallel (S/P) conversion circuit 22. The S/P conversion circuit 22 is adapted to convert the resultant signal, DESCR_RXD, which is input to its input 20, from its serial form, beginning with the PR bits and ending with the CRC bits, to a 220-bit parallel form of data, P_DESCR_RXD [219:0], and outputs the converted data on its output 24. The parallel output 24 is connected to a 1-bit error correction circuit 26.

The 1-bit error correction circuit 26, which is adapted to perform CRC error correction on input data, performs 1-bit error correction on the 196-bits of the input data, P_DESCR_RXD[219:0], beginning with the CI bits and generates the result as error-corrected received data. The 1-bit error correction circuit 26 outputs data, P_PR2SA[43:0], corresponding to the 44 bits, beginning with the PR bits and ending with the SA bits, to a received data storage register 32 connected to its one output 30. The 1-bit error correction circuit 26 also outputs 160-bit data, P_DATASEC[159:0], on which the user scrambling is performed, to a parallel exclusive OR (EXOR) circuit 40 connected to its another output 34.

On the other hand, when the user scramble pattern generation circuit 42 receives on its input 43 initial value data, INITSEC[15:0], for user descrambling, it sequentially generates a PN pattern, PNSEC, which is used for descrambling data scrambled via user scramble, based on the initial value data, INITSEC[15:0], 43 and serially outputs the generated pattern on its output 44. This output 44 is connected to a serial-to-parallel (S/P) conversion circuit 46. The S/P conversion circuit 46 converts the received PN pattern, PNSEC, 44 to 160-bit parallel data, P_PNSEC[159:0], and outputs the converted data on its output 48. The output 48 of the S/P conversion circuit 46 is connected to the parallel exclusive OR (EXOR) gate circuit 40.

The parallel EXOR gate circuit 40, a parallel operation circuit including 160 EXOR operation circuits each performing the exclusive OR operation, is adapted to operate the exclusive OR on the PN pattern, P_PNSEC[159:0], converted into a parallel form with the CRC error-corrected parallel data, P_DATASEC[159:0], 34, in a bit by bit and parallel fashion. This configuration enables the user descrambling, conventionally performed serially, to be performed in parallel. The parallel EXOR gate 40 outputs the data, P_TCH[159:0], on which the user descrambling is performed, to its output 50 in parallel. This output 50 is connected to one of the inputs of the received data storage register 32. The received data storage register 32 has its other input interconnected to the output, P_PR2SA[43:0], 30 of the 1-bit error correction circuit 26. The received data storage register 32 stores this data.

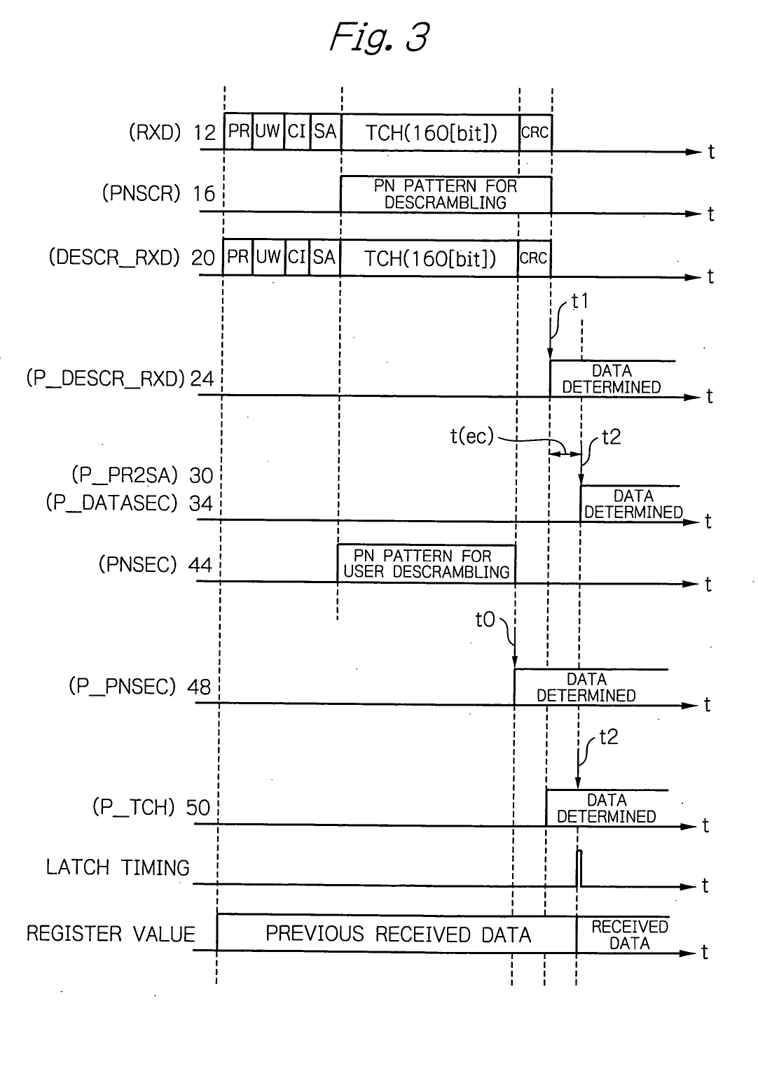

The operation of the descrambler 10 with the configuration described above will be described with reference to FIG. 3. The scramble pattern generation circuit 14 generates a PN pattern, PNSCR, 16 for descrambling. The exclusive OR gate 18 operates the exclusive OR on the PN pattern data, PNSCR, 16 and the received data, RXD, 12 to perform descrambling. The data, DESCR_RXD, 20 generated by this processing is converted by the S/P conversion circuit 22 to the 220-bit parallel data, P_DESCR_RXD, 24 beginning with the PR bits and ending with the CRC bits. The 1-bit error correction circuit 26, which performs CRC error correction, makes 1-bit error correction on the 196-bit data of the received data, P_DESCR_RXD, 24 beginning with the CI bits to generate data as error corrected received data. The 1-bit error correction circuit 26 outputs two types of data: one is data, P_PR2SA, 30 corresponding to the 44 bits from the PR bits to the SA bits and the other is 160-bit data, P_DATASEC, 34 for which the user scrambling has been performed.

The two types of data, P_DATASEC, 34 and, P_PR2SA, 30, are determined or established at time t2, which is the same as in the prior-art configuration. By contrast, the user descrambling that is performed from this point on differs greatly from that in the prior art. The period of time t(ec) from time t1 to time t2 is the time required for the CRC error correction. This operation time depends, for example, on the conditions such as the circuit configuration and the operation clock of the 1-bit error correction circuit 26.

The PN pattern, PNSEC, 44 for descrambling the user scramble data is determined uniquely by the initial value data, INITSEC, 43 generated based on a encryption key code. Therefore, the 160-bit PN pattern, PNSEC, 44 is generated by the user scramble pattern generation circuit 42 before time to in advance and is converted to the 160-bit parallel data, P_PNSEC, by the S/P conversion circuit 46 so that the data can be output in the parallel form. Time t0 at which this conversion is completed may be any point of time before the time the 1-bit error correction circuit 26 completes the 1-bit error correction. The parallel EXOR gate 40 performs user descrambling for the data in parallel. The data, P_TCH, 50 on which the user descrambling has been performed is determined at t2 at which the CRC error correction is terminated and the data, P_DATASEC, 34 is determined. Immediately after that, the data, P_TCH, 50 as well as the data, P_PR2SA, 30 can be latched into the received data storage register 32.

As described above, in the embodiment shown in FIGS. 1, 2 and 3, the user descrambling can be processed in parallel and the time required to store received data into the register can be reduced. This configuration also eliminates the need for the parallel-to-serial conversion circuit as required in the prior-art and the control circuit which would otherwise be required for performing complicated control, and therefore reduces the circuit scale.

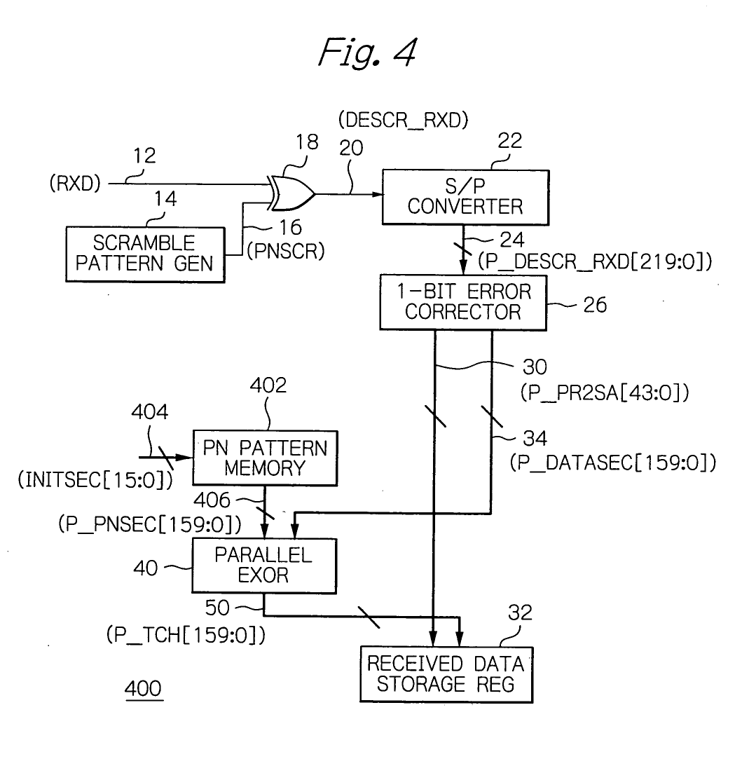

Next, an alternative embodiment of a user descrambler will be described with reference to FIG. 4. Referring to the figure, another configuration 400 of a descrambler 400 of the descrambler comprises a PN pattern storage memory 402, which has the 16-bit length of address representation and the 160-bit length of data, instead of the user scramble pattern generation circuit 42 and the S/P conversion circuit 46 of the descrambler 10 shown in FIG. 1. The PN pattern storage memory 402 is adapted to store PN pattern data associated with an input address. The PN pattern storage memory 402 has its address input 404, which receives any initial value data, INITSEC[15:0], which ranges from “0000h” to “FFFFh”. Therefore, when the initial value data, INITSEC[15:0], 404 is input as an address, the corresponding PN pattern data, P_PNSEC[159:0], is determined in the PN pattern storage memory 402. The PN pattern storage memory 402A has its data output, P_PNSEC[159:0], 406 connected to one input of the parallel EXOR gate 40. The configuration of the other components may the same as that of the embodiment shown in FIG. 1.

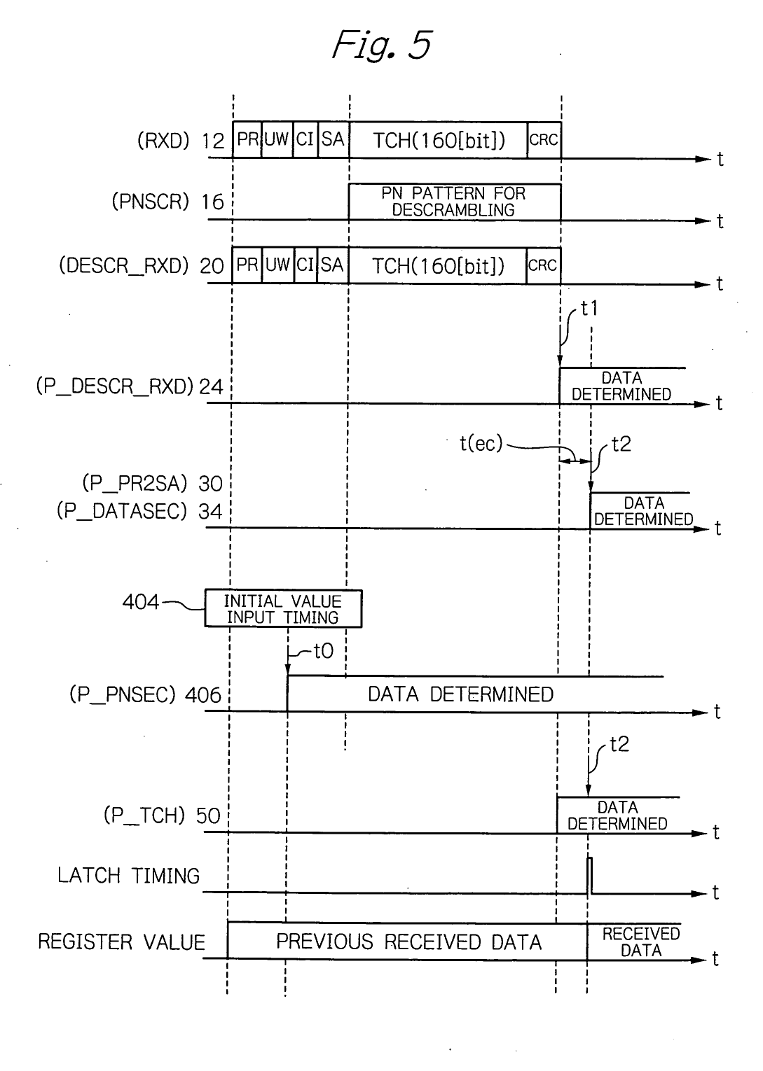

The operation of the descrambler 400 with the configuration described above will be described with reference to FIG. 5. FIG. 5 is a timing diagram on the operation of the descrambler 400. In this embodiment, the time at which the data, P_PNSEC[159:0], 406 is determined is different from that in the timing diagram of FIG. 3. That is, the data, P_PNSEC[159:0], 406 is determined at time to.

When the PN pattern storage memory 402 receives the initial value data, INITSEC, 404, it establishes the data, P_PNSEC[159:0], and becomes in the sate in which it can output the thus established data. Therefore, in timed with the data, P_DATASEC, 34 being input to the parallel EXOR gate 40, the PN pattern data, P_PNSEC [159:0], 406 for descrambling the user scramble data can be supplied from the PN pattern storage memory 402 to the parallel EXOR gate 40 to descramble the simplified user scramble data.

As described above with this embodiment, when the initial value data, INITSEC, 404 is input to the address input terminal 404 of the PN pattern storage memory 402, a 160-bit parallel PN pattern is output from the PN pattern storage memory 402. This configuration eliminates the need for the user scramble pattern generation circuit 42 and the S/P conversion circuit 46 included in the embodiment shown in FIG. 1, thus making the time control simpler. In addition, when the generation polynomial for the PN pattern is changed, it is only required to rewrite the data stored in the PN pattern storage memory 402.

The entire disclosure of Japanese patent application No. 2003-384203 filed on Nov. 13, 2003, including the specification, claims, accompanying drawings and abstract of the disclosure is incorporated herein by reference in its entirety.

While the present invention has been described with reference to the particular illustrative embodiments, it is not to be restricted to the embodiments. It is to be appreciated that those skilled in the art can change or modify the embodiments without departing from the scope and spirit of the present invention.

1. A descrambler for descrambling scrambled parallel data, comprising:
a pattern generator for generating a descramble pattern for descrambling the parallel data;
a converter for converting the descramble pattern to a parallel form; and
an operation circuit connected to said converter for receiving the descramble pattern in the parallel form and the parallel data for performing a bit-by-bit exclusive OR operation.

2. The descrambler in accordance with claim 1, further comprising a corrector for performing error correction on a received signal in a parallel form and outputting the signal error-corrected as parallel data,
said operation circuit being connected to an output of said corrector for receiving the parallel data from said corrector.

3. A descrambler for descrambling scrambled parallel data, comprising:
a pattern generator for holding a descramble pattern for descrambling the parallel data, receiving initial value data for descrambling as address data, and outputting data of the descramble pattern according to the initial value data in a parallel form; and
an operation circuit connected to said pattern generator for receiving the data of the descramble pattern and the parallel data for performing a bit-by-bit exclusive OR operation.

4. The descrambler in accordance with claim 3, further comprising:
a corrector for performing error correction on a received signal in a parallel form and outputting the signal error-corrected as parallel data,
said operation circuit being connected to an output of said corrector for receiving the parallel data from said corrector.
